(19) United States
(12) Patent Application Publication
(10) Pub. No.: US 2021/0081985 A1
(43) Pub. Date: Mar. 18, 2021

(54) ADVERTISEMENT INTERACTION METHODS AND APPARATUSES, ELECTRONIC DEVICES AND STORAGE MEDIA

(71) Applicant: Beijing Sensetime Technology Development Co., Ltd., Beijing (CN)

(72) Inventors: Qinqin XU, Beijing (CN); Qing LUAN, Beijing (CN)

(21) Appl. No.: 17/107,319

(22) Filed: Nov. 30, 2020

Related U.S. Application Data
(63) Continuation of application No. PCT/CN2018/124002, filed on Dec. 26, 2018.

(30) Foreign Application Priority Data
Jun. 1, 2018 (CN) 201810558365.4

(51) Int. Cl. G06Q 30/02

(52) U.S. Cl. CPC G06Q 30/0242; G06Q 30/0277

(57) ABSTRACT

The present disclosure relates to an advertisement interaction method and apparatus, electronic device, and storage medium. The method includes: sending an advertisement interaction request for running interactive advertisements to a server or a cloud database; in response to receiving a response to the advertisement interaction request from the server or the cloud database, running the interactive advertisement; in response to the interactive advertisement ending, displaying a result page which includes result information obtained from the running of the interactive advertisement.

The present application is a continuation of International Patent Application Serial No. PCT/CN2018/124002 filed on Dec. 26, 2018, which claims priority to Chinese Patent Application No. 201810558365.4 entitled “ADVERTISEMENT INTERACTION METHODS AND APPARATUSES, ELECTRONIC DEVICES, AND STORAGE MEDIA” filed on Jun. 1, 2018, the disclosure of all of which is incorporated herein by reference in their entirety.

### TECHNICAL FIELD

The present disclosure relates to the field of computer technology, in particular to advertisement interaction methods and apparatuses, electronic devices and storage media.

### BACKGROUND

After using an application (APP), a user may exit the APP directly, which results in a short time of the user staying on an interface of the APP. In related arts, some APPs may play advertisements at some timings, but the effect of the advertisements may be poor, which cause the user to leave the interfaces of the APPs.

### SUMMARY

The present disclosure provides advertisement interaction methods and apparatuses, electronic devices and storage media.

According to an aspect of the present disclosure, an advertisement interaction method is provided, which is applicable to a terminal, and includes:

sending an advertisement interaction request for running an interactive advertisement to a server or a cloud database;

in response to receiving a response to the advertisement interaction request from the server or the cloud database, running the interactive advertisement;

in response to the interactive advertisement ending, displaying a result page which includes result information obtained from the running of the interactive advertisement.

In an embodiment, sending the advertisement interaction request for running the interactive advertisement to the server or the cloud database includes:

in response to that a control of the terminal for starting the interactive advertisement is triggered, sending the advertisement interaction request to the server or the cloud database.

In an embodiment, the method further includes:

in response to that a control of the terminal for starting the interactive advertisement is triggered, sending historical behavior information and/or user identity information of the terminal to the server or the cloud database.

In an embodiment, in response to receiving the response to the advertisement interaction request from the server or the cloud database, running the interactive advertisement includes:

in response to receiving the response to the advertisement interaction request from the server or the cloud database, starting at least one of an image acquisition component and a sound acquisition component of the terminal to acquire at least one of an image and a sound;

running the interactive advertisement in an augmented reality (AR) mode based on the at least one of the image and the sound.

In an embodiment, running the interactive advertisement in the AR mode based on the at least one of the image and the sound includes:

identifying an object involved in the image;

overlay displaying the identified object and virtual contents of the interactive advertisement in the AR mode.

In an embodiment, running the interactive advertisement in the AR mode based on the at least one of the image and the sound includes:

identifying, based on the image, one or more of a line-of-sight, an expression, a posture, and a gesture of a user of the terminal;

interacting with virtual contents of the interactive advertisement based on the one or more of the line-of-sight, the expression, the posture, and the gesture.

In an embodiment, running the interactive advertisement in the AR mode based on the at least one of the image and the sound includes:

identifying the sound;

interacting with virtual contents of the interactive advertisement based on a result of the identification.

In an embodiment, in response to receiving a response to the advertisement interaction request from the from the server or the cloud database, running the interactive advertisement includes:

in response to receiving the response to the advertisement interaction request from the server or the cloud database, starting at least one of the image acquisition component and the sound acquisition component of the terminal to acquire the at least one of the image and the sound;

determining a running parameter of the interactive advertisement based on the at least one of the image and the sound.

In an embodiment, the method further includes:

in response to the interactive advertisement ending, determining the result information based on the running parameter.

In an embodiment, the method further includes: in response to that an activation to the result page is detected, displaying a content page corresponding to the interactive advertisement.

In an embodiment, the content page corresponding to the interactive advertisement includes at least one of the following:

a consumption page for consuming contents corresponding to the interactive advertisement;

a page for promoting consumption of the contents corresponding to the interactive advertisement.

In an embodiment, the method further includes: in response to that an activation to a control for forwarding the result information is detected, forwarding the result information.

In an embodiment, the result information includes reward information for running the interactive advertisement.

In an embodiment, the interactive advertisement includes an interactive game.

In an embodiment, the response to the advertisement interaction request includes an address of the interactive advertisement or contents of the interactive advertisement.

In an embodiment, the terminal includes a software development kit (SDK), and the SDK is configured to send the interactive advertisement request for running the interactive advertisement to the server or the cloud database and to run the interactive advertisement.

According to an aspect of the present disclosure, an advertisement interaction method is provided, which is applicable to a server or a cloud database, and includes:

in response to receiving an advertisement interaction request from a terminal, determining an interactive advertisement corresponding to the advertisement interaction request;

sending, based on the determined interactive advertisement, a response to the advertisement interaction request to the terminal.

In an embodiment, in response to receiving the advertisement interaction request from the terminal, determining the interactive advertisement corresponding to the advertisement interaction request includes:

in response to receiving the advertisement interaction request from the terminal, obtaining historical behavior information and/or user identity information of the terminal;

determining the interactive advertisement corresponding to the advertisement interaction request based on the historical behavior information and/or the user identity information of the terminal.

In an embodiment, the method further includes:

determining a type of a plug-in included in the interactive advertisement based on feature information of an advertisement publisher.

In an embodiment, the response to the advertisement interaction request includes an address of the interactive advertisement or contents of the interactive advertisement.

In an embodiment, the interactive advertisement includes an interactive game.

According to an aspect of the present disclosure, an advertisement interaction apparatus is provided, including:

a request sending module, configured to send an advertisement interaction request for running an interactive advertisement to a server or a cloud database;

a running module, configured to, in response to receiving a response to the advertisement interaction request from the server or the cloud database, run the interactive advertisement;

a result page displaying module, configured to, in response to the interactive advertisement ending, display a result page which includes result information obtained from the running of the interactive advertisement.

In an embodiment, the request sending module includes:

a request sending sub-module, configured to, in response to that a control of the terminal for starting the interactive advertisement is triggered, send the advertisement interaction request to the server or the cloud database.

In an embodiment, the apparatus may further include:

an information sending module, configured to, in response to that the control for starting the interactive advertisement of the terminal is triggered, send historical behavior information and/or user identity information of the terminal to the server or the cloud database.

In an embodiment, the running module includes:

a first acquisition sub-module, configured to, in response to receiving the response to the advertisement interaction request from the server or the cloud database, start at least one of an acquisition component and a sound acquisition component of the terminal to acquire at least one of an image and a sound;

an AR sub-module, configured to run the interactive advertisement in an AR mode based on the at least one of the image and the sound.

In an embodiment, the AR sub-module includes:

an image identifying sub-module, configured to identify an object involved in the image;

an overlay displaying sub-module, configured to overlay display the identified object and virtual contents of the interactive advertisement in an AR mode.

In an embodiment, the AR sub-module includes:

an image identifying sub-module, configured to identify, based on the image, one or more of a line-of-sight, an expression, a posture, and a gesture of a user of the terminal;

a first interaction sub-module, configured to interact with virtual contents of the interactive advertisement based on the one or more of the line-of-sight, the expression, the posture, and the gesture.

In an embodiment, the AR sub-module includes:

a sound identifying sub-module, configured to identify the sound;

a second interaction sub-module, configured to interact with virtual contents of the interactive advertisement based on a result of the identification.

In an embodiment, the running module includes:

a second acquisition sub-module, configured to, in response to receiving the response to the advertisement interaction request from the server or the cloud database, start at least one of the image acquisition component and the sound acquisition component of the terminal to acquire the at least one of the image and the sound;

a running parameter determining sub-module, configured to determine a running parameter of the interactive advertisement based on the at least one of the image and the sound.

In an embodiment, the apparatus further includes:

a result information determining module, configured to, in response to the interactive advertisement ending, determine the result information based on the running parameter.

In an embodiment, the apparatus further includes:

a result information determining module, configured to, in response to the interactive advertisement ending, determine the result information based on the running parameter.

In an embodiment, the apparatus further includes:

a content displaying module, configured to, in response to that an activation to the result page is detected, display a content page corresponding to the interactive advertisement.

In an embodiment, the content page corresponding to the interactive advertisement includes at least one of the following:

a consumption page for consuming contents corresponding to the interactive advertisement;

a page for promoting consumption of the contents corresponding to the interactive advertisement.

In an embodiment, the apparatus further includes:

a forwarding module, configured to, in response to that an activation to a control for forwarding the result information is detected, forward the result information.

In an embodiment, the result information includes reward information for running the interactive advertisement.

In an embodiment, the interactive advertisement includes an interactive game.

In an embodiment, the response to the advertisement interaction request includes an address of the interactive advertisement or contents of the interactive advertisement.

In an embodiment, the terminal includes a SDK, and the SDK is configured to send the interactive advertisement request for running the interactive advertisement to the server or the cloud database and to run the interactive advertisement.

According to an aspect of the present disclosure, an advertisement interaction apparatus is provided, including:

an interactive advertisement determining module, configured to, in response to receiving an advertisement interaction request from a terminal, determine an interactive advertisement corresponding to the advertisement interaction request;

a response sending module, configured to send, based on the determined interactive advertisement, a response to the advertisement interaction request to the terminal.

In an embodiment, the interactive advertisement determining module includes:

an information acquisition sub-module, configured to, in response to receiving an advertisement interaction request from the terminal, obtain historical behavior information and/or user identity information of the terminal;

an interactive advertisement determining sub-module, configured to determine the interactive advertisement corresponding to the advertisement interaction request based on the historical behavior information and/or the user identity information of the terminal.

In an embodiment, the apparatus further includes:

a plug-in determining module, configured to determine a type of a plug-in included in the interactive advertisement based on feature information of an advertisement publisher.

In an embodiment, the response to the advertisement interaction request includes an address of the interactive advertisement or contents of the interactive advertisement.

In an embodiment, the interactive advertisement includes an interactive game.

According to an aspect of the present disclosure, an electronic device is provided, including:

A processor;

a memory for storing executable instructions by the processor;

wherein the processor is configured to implement the above advertisement interaction methods.

According to an aspect of the present disclosure, a computer readable storage medium is provided, the computer readable storage medium having computer program instruction stored thereon, when executed by a processor, implement the above advertisement interaction methods.

In the embodiment of the present disclosure, by running an interactive advertisement to interact with the user, the stay time of the user on the interface can be effectively increased, and by interacting with the user, the user can be attracted and the advertisement effect can be improved.

According to the following detailed description of exemplary embodiments with reference to the accompanying drawings, other features and aspects of the present disclosure will become clear.

### BRIEF DESCRIPTION OF THE DRAWINGS

The accompanying drawings constituting a part of the specification illustrate some embodiments of the present disclosure and are intended to explain the principles of the present disclosure together with the description.

FIG. 1 illustrates a flowchart of an advertisement interaction method according to some embodiments of the present disclosure.

FIG. 2 illustrates a flowchart of an advertisement interaction method according to some embodiments of the present disclosure.

FIG. 3 illustrates a flowchart of an advertisement interaction method according to some embodiments of the present disclosure.

FIG. 4 illustrates a flowchart of step S12 of an advertisement interaction method according to some embodiments of the present disclosure.

FIG. 5 illustrates a flowchart of step S12 of an advertisement interaction method according to some embodiments of the present disclosure.

FIG. 6 illustrates a flowchart of an advertisement interaction method according to some embodiments of the present disclosure.

FIG. 7 illustrates a flowchart of an advertisement interaction method according to some embodiments of the present disclosure.

FIG. 8 illustrates a flowchart of an advertisement interaction method according to some embodiments of the present disclosure.

FIG. 9 illustrates a flowchart of an advertisement interaction method according to some embodiments of the present disclosure.

FIG. 10 illustrates a flowchart of step S91 of an advertisement interaction method according to some embodiments of the present disclosure.

FIG. 11 illustrates a flowchart of an advertisement interaction method according to some embodiments of the present disclosure.

FIG. 12 illustrates an application schematic diagram of an advertisement interaction method according to some embodiments of the present disclosure.

FIG. 13 illustrates a block diagram of an advertisement interaction apparatus according to some embodiments of the present disclosure.

FIG. 14 illustrates a block diagram of an advertisement interaction apparatus according to some embodiments of the present disclosure.

FIG. 15 illustrates a block diagram of an advertisement interaction apparatus according to some embodiments of the present disclosure.

FIG. 16 illustrates a block diagram of an advertisement interaction apparatus according to some embodiments of the present disclosure.

FIG. 17 illustrates a block diagram of an electronic device according to some embodiments of the present disclosure.

FIG. 18 illustrates a block diagram of an electronic device according to some embodiments of the present disclosure.

### DETAILED DESCRIPTION OF THE EMBODIMENTS

Various exemplary embodiments, features, and aspects of the present disclosure will be described in detail below with reference to the accompanying drawings. Like reference numerals in the drawings indicate elements with the same or similar functions. Although various aspects of the embodiments are shown in the drawings, unless otherwise noted, the drawings are not necessarily drawn to scale.

The dedicated word “exemplary” here means “serving as an example, embodiment, or illustration.” Any embodiment described herein as “exemplary” need not be construed as being superior or better than other embodiments.

In addition, in order to better illustrate this application, numerous specific details are given in the following specific implementations. Those skilled in the art should understand that the present disclosure can also be implemented without certain specific details. In some examples, the methods, means, elements, and circuits well known to those skilled in the art have not been described in detail in order to highlight the subject matter of the present disclosure.

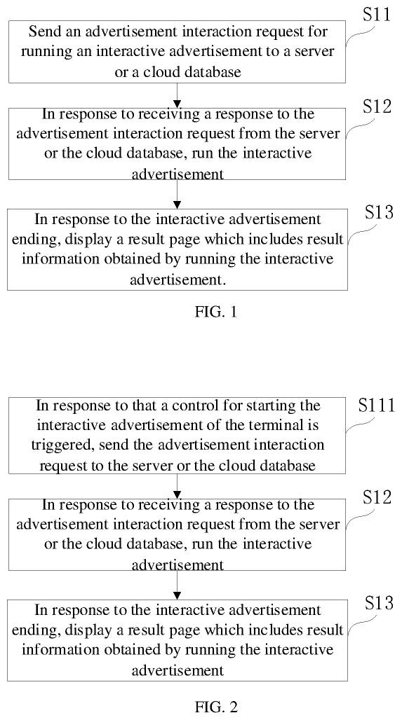

FIG. 1 illustrates a flowchart of an advertisement interaction method according to some embodiments of the present disclosure; As shown in FIG. 1, the method is applicable to a terminal and the method includes steps S11 to S13.

At step S11, an advertisement interaction request for running an interactive advertisement is sent to a server or a cloud database.

At step S12, the interactive advertisement is run in response to receiving a response to the advertisement interaction request from the server or the cloud database.

At step S13, in response to the interactive advertisement ending, a result page is displayed, which includes result information obtained by running the interactive advertisement.

According to the advertisement interaction method of the embodiment of the present disclosure, by running interactive advertisements to interact with users, the stay time of the user on the interface can be effectively increased, and the user can be attracted by the interaction which improves the advertisement effect.

In an embodiment, the advertisement interaction method may be executed by a terminal, which may be a user equipment (UE), a mobile device, a user terminal, a cellular phone, a cordless phone, or a personal digital processing assistant. (PDA), a handheld device, a computing device, a vehicle-mounted device, a wearable device, etc. The method can be implemented by a processor calling computer-readable instructions stored in a memory. The terminal includes a software development kit (SDK), which is used to send the advertisement interaction request for running the interactive advertisement to a server or a cloud database and to run the interactive advertisement. The SDK may be a toolkit embedded in the terminal.

In an embodiment, at step S11, the terminal may send an advertisement interaction request to the server or the cloud database to run the advertisement, and the advertisement interaction request may be a packet for requesting interactive advertisement resources from the server or the cloud database. In an example, the SDK may send the advertisement interaction request to the server or the cloud database.

In an embodiment, the terminal may send the advertisement interaction request to the server or the cloud database when the user triggers a control for starting the interactive advertisement.

FIG. 2 illustrates a flowchart of an advertisement interaction method according to some embodiments of the present disclosure. As shown in FIG. 2, step S11 may include:

when a control of the terminal for starting the interactive advertisement is triggered, the advertisement interaction request is sent to the server or the cloud database.

In an embodiment, the control for starting the interactive advertisement may include an advertisement slot in an application (APP) (for example, an area for displaying advertisement in an APP interface), icons of at least a part of the APPs on the terminal, or an icon of an APP dedicated to running the interactive advertisement.

In an example, the advertisement slot in the APP may include an icon for starting interactive advertisement inserted in the area for displaying advertisements in the APP interface. When the icon is triggered, the SDK may send the advertisement interaction request to the server or the cloud database. The advertisement slot in the APP may also include an advertisement for playing on the APP interface. For example, in an APP for playing videos, an advertisement may be played before playing the video contents. If the advertisement playing interface is triggered while the advertisement is being played, the SDK may send the advertisement interaction request to the server or the cloud database. The advertisement slot in the APP may also include a floating window, a banner, or a pop-up window in the APP interface. The floating window, the banner, or the pop-up window may include a link to the interactive advertisement or an icon for starting the interactive advertisement. When the link or the icon is triggered, the SDK may send the advertisement interaction request to the server or the cloud database. The advertisement slot in the APP may also include an advertisement page displaying upon the APP is started. When the advertisement page is triggered, the SDK may send the advertisement interaction request to the server or the cloud database. The present disclosure does not limit the type of the advertisement slot.

In an example, when the icons of at least part of the APPs on the terminal are triggered, that is, when the at least part of the APP is started, the SDK may send the advertisement interaction request to the server or the cloud database. For example, when an APP (such as a camera APP, a live broadcast APP, or an APP for shooting short videos) for starting the video acquisition component of the terminal is started, the SDK may send the advertisement interaction request to the server or the cloud database.

In an example, when the icon of the APP dedicated to running the interactive advertisement is triggered, that is, when the APP dedicated to running the interactive advertisement is started, the SDK may send the advertisement interaction request to the server or the cloud database.

In an embodiment, the terminal may also send historical behavior information and/or user identity information of the terminal to the server or the cloud database, so that the server or the cloud database can determine a type of the interactive advertisement to be pushed based on the historical behavior information and/or the user identity information.

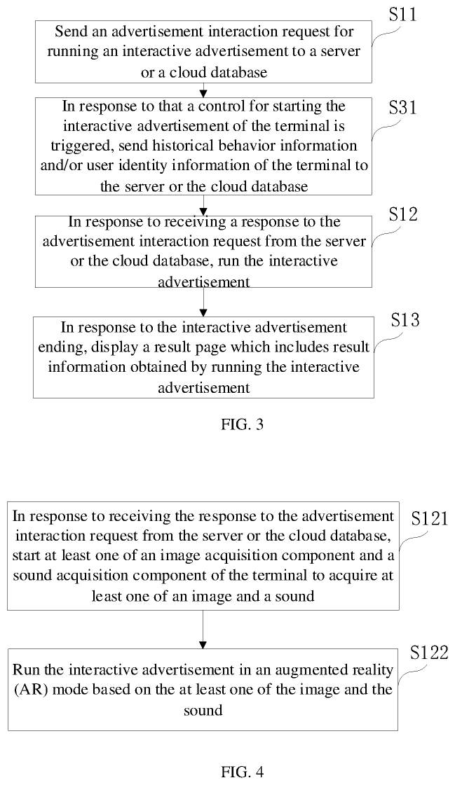

FIG. 3 illustrates a flowchart of an advertisement interaction method according to some embodiments of the present disclosure. As shown in FIG. 3, the advertisement interaction method further includes step S31.

At step S31, when the control for starting the interactive advertisement of the terminal is triggered, historical behavior information and/or user identity information of the terminal is sent to the server or the cloud database.

In an embodiment, the historical behavior information may include historical operation records of the user operating the terminal or user behavior information recorded by the terminal. For example, the historical operation records may include historical purchase information of the user on a website or APP, the user behavior information recorded by the terminal may include exercise records or schedule of the user recorded by the terminal. The user identity information may be information indicating the identity of the user, and may include information such as name, citizenship, age, education, and occupation of the user. Based on the historical behavior information, user preferences, and other information can be determined. The terminal may send the historical behavior information to the server or the cloud database, so that the server or the cloud database can use the historical behavior information of the terminal to determine the type of the interactive advertisement. The terminal may also send the user identity information to the server or the cloud database, so that the server or the cloud database can determine the type of the interactive advertisement based on the user identity information. Alternatively, the server or the cloud database may determine the type of the interactive advertisement based on both the user identity information and historical behavior information. This application does not limit the type of information sent by the terminal to the server.

In this way, the interactive advertisement can be accurately pushed to the user of the terminal, and the effect of the interactive advertisement can be improved.

In an embodiment, at step S12, when the server or the cloud database responds to the advertisement interaction request, the terminal may receive the response to the advertisement interaction request from the server or the cloud database, and may parse the response to run the interactive advertisement. In an example, the response to the advertisement interaction request includes an address of the interactive advertisement or contents of the interactive advertisement.

FIG. 4 illustrates a flowchart of step S12 of the advertisement interaction method according to some embodiments of the present disclosure. As shown in FIG. 4, step S12 may include steps S121 and S122.

At step S121, in response to receiving the response to the advertisement interaction request from the server or the cloud database, at least one of an image acquisition component and a sound acquisition component of the terminal is started to acquire at least one of an image and a sound.

At step S122, the interactive advertisement is run in an augmented reality (AR) mode based on the at least one of the image and the sound.

In an embodiment, at step S121, in response to receiving the terminal receiving the response to the advertisement interaction request from the server or the cloud database, at least one of the image acquisition component (for example, a camera) and the sound acquisition component (for example, a microphone) may be started, such that at least one of the image or the sound around the terminal can be acquired, for example, at least one of an image of the user of the terminal, an image of the environment, and a voice of the user of the terminal can be acquired.

In an embodiment, at step S122, the SDK may load the interactive advertisement so that the terminal can display virtual contents of the interactive advertisement, for example, display virtual objects in the interactive advertisement (such as characters and props in the game) and play the sound of the interactive advertisement. Through real contents such as images and sounds acquired by the image acquisition component and the sound acquisition component and the virtual contents of the interactive advertisement, AR-based interaction can be realized.

In an example, the interactive advertisement may include an interactive game, and the terminal may use at least one of the image and the sound of the user to play the interactive game.

The following takes the interactive games as examples to illustrate the examples of running the interactive advertisement based on at least one of the image and the sound.

In an example, running the interactive advertisement based on the at least one of the image and the sound in the AR mode may include: identifying an object in the image; overlay displaying the identified object and virtual contents of the interactive advertisement in the AR mode. For example, the terminal may activate a camera to acquire an image. The image may involve a current user of the terminal, an object in the environment where the current user is located, and an accessory worn by the current user. The camera may transmit the image to a CPU of the terminal, and the CPU may identify the object in the image by methods such as deep learning. Further, the object identified from the image can be superimposed with the virtual contents of the interactive game loaded by the SDK. For example, a head image of the user can be superimposed with the body of the virtual character in the interactive game, so that the current user of the terminal can interact with the interactive game in the AR mode.

In an example, running the interactive advertisement in the AR mode based on the at least one of the image and the sound may include: identifying one or more of a line-of-sight, an expression, a posture, and a gesture of the user of the terminal based on the image; interacting with the virtual contents of the interactive advertisement based on the one or more of the line-of-sight, the expression, the posture, or the gesture.

The virtual contents can be controlled or changed (for example, parameters of the virtual contents can be changed such that the virtual contents can respond accordingly) based on parameters of the line-of-sight, the expression, the posture, or the gesture (such as a direction and focal point of the line-of-sight; a type of the expression; a type, direction, and amplitude of the posture or gesture, etc.).

For example, the terminal may activate the camera to acquire an image which may involve the current user of the terminal. The camera may transmit the image to the CPU of the terminal. The CPU may identify one or more of the line-of-sight, the expression, the posture, or the gesture of the user in the image through methods such as deep learning, and may run the interactive advertisement based on a result of the identification, such as control the virtual contents of the interactive advertisement.

For example, the camera may determine the line-of-sight direction of the user by acquiring a facial image of the user, and control a target object in a game screen according to the line-of-sight direction, so as to avoid obstacles on the game screen or hit objects on the game screen. For example, the game may involve attacking airplanes on the game screen, avoiding blocks on the game screen, collecting heart-shaped objects on the game screen, or searching for treasures on the game screen, etc. A cursor may appear at a point that the line-of-sight is targeting on the screen of the interactive game, and when the line-of-sight of the user moves, the cursor may move correspondingly. When the cursor is in contact with an airplane on the game screen, the screen may display an attack to the airplane. When the cursor is in contact with a block on the game screen, the screen may display a failure of avoiding the block, and when the cursor is in contact with a heart-shaped object or treasure, the screen may display a collection of the heart-shaped object or the treasure.

For another example, the expression of the user can be identified by acquiring the facial image of the user, and an interactive game related to the expression can be run based on the expression. For example, the interactive game may be a bubble-spitting game, the user may make expressions such as pouting, and bubbles may appear on the screen of the interactive game.

For another example, the terminal may identify a head movement of the current user according to images of the current user. A game such as avoiding obstacles can be run on the game screen according to the head movement of the user. For example, the game may be a game involves head avoiding obstacles. Obstacles and the image of the head of the user may appear on the game screen. The obstacles may move toward the image of the head. When the head of the user swings, the image of the head may swing correspondingly to avoid obstacles. If an obstacle is in contact with the image of the head, the game screen may display the image of the head being hit.

For another example, the terminal may identify the gesture or body motion of the current user of the terminal based on the image, and run the interactive game according to the gesture or body motion. For example, the game may be a game involves shooting a basket based on the gesture or body motion, or a game involves catching treasures or smashing golden eggs on the screen based on the gesture or body motion, or a game involves making designated body motions, or a game involves using gestures or body motions to attack a target on the game screen, such as a boxing game or a monster fighting game. In an example, images of a basket, a basketball, and hands of the user may appear on the game screen. When the gesture of the user changes, the image of the hands may change accordingly. For example, if the gesture of the user is a shooting posture, the image of the hands on the game screen may be displayed as a shooting posture and shooting the basketball into the basket. In an example, images of a monster, a weapon, and the hands of the user may appear on the game screen. When the gesture of the user is a clenched fist, the image of the hands can be displayed as a clenched fist, which can attack the monster. The user may also take an action of picking up the weapon, the image of the hands on the game screen may be displayed as the hands holding the weapon, which can be used to attack the monster. In addition, the user may hold an object such as a pen, the terminal may detect the pen and other objects and display the image of the hands as hands holding the weapon, and the weapon can be used to attack the monster. In an example, images of golden eggs and a hammer may appear on the game screen, and the user can take an action of picking up the hammer. The image of the hands on the game screen may be displayed as the hands holding the hammer, and the hammer can be used to smash the golden eggs.

In an embodiment, running the interactive advertisement in the AR mode based on the at least one of the image and the sound may include: identifying the sound; and interacting with the virtual contents of the interactive advertisement based on a result of the identification.

In an example, the terminal may activate a microphone to acquire the sound. In an example, the microphone may provide the acquired sound to the CPU, and the CPU may identify the sound, for example, using a voice identifying function to identify the sound, and run an interactive game according to the result of the voice identification. For example, the game may be a word guessing game, and a result of the word guessing game can be determined according to the result of the voice identification. For example, if the result of the voice identification is identical to the answer of the word guessing game, the result of the word guessing game is correct, otherwise it is wrong.

In the example, the interactive game may be a 2D game or a 3D game, and the present disclosure does not limit the rendering effect of the game. An advertisement can be inserted in the game. For example, the game is a shooting game, a sphere area of a basketball or a board area can be set as an advertisement slot, and the advertisement may be displayed in the advertisement slot of the sphere area of the basketball or the board area. For example, the game is a monster fighting game, and an area of monster skin can be set as an advertisement slot, and the advertisement may be displayed in the advertisement slot of the area of the monster skin. The present disclosure does not limit the advertisement slot in the game.

In this way, users may interact with the virtual contents in the interactive advertisement in the AR mode, and may interact with the virtual contents to stay on the interface of the interactive advertisement for longer time, which improves sensory experience of the user and the effect of advertising.

In an embodiment, at step S12, the terminal may also determine a running parameter for running the interactive advertisement.

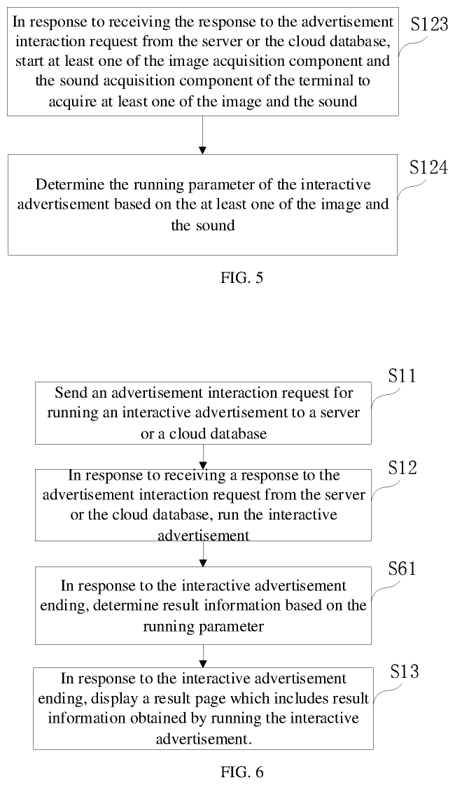

FIG. 5 illustrates a flowchart of step S12 of the advertisement interaction method according to some embodiments of the present disclosure. As shown in FIG. 5, step S12 may include:

At step S123, in response to receiving the response to the advertisement interaction request from the server or the cloud database, at least one of the image acquisition component and the sound acquisition component of the terminal is started to acquire at least one of the image and the sound.

At step S124, the running parameter of the interactive advertisement is determined based on the at least one of the image and the sound.

In an embodiment, at step S123, upon the terminal receiving the response to the advertisement interaction request from the server or the cloud database, at least one of the image acquisition component and the sound acquisition component of the terminal can be started, for example, the at least one of a camera and a microphone of the terminal is used to acquire at least one of the image and the sound.

In an embodiment, at step S124, the SDK may load the interactive advertisement, and run the interactive advertisement based on the at least one of the image and the sound. For example, at least one of the image and the sound may be used to interact with the interactive advertisement, such as using the expression and language of the current user of the terminal to interact with the interactive advertisement.

In an embodiment, the interactive advertisement may be run and the running parameter of the interactive advertisement may be determined based on the at least one of the image and sound of the current user of the terminal. The running parameter may include a parameter generated by running the interactive advertisement, such as a score for participating in an interactive game. In an example, the interaction may be conducted in a form of question and answer, and the running parameter of the interactive advertisement, that is, the score obtained by running the interactive advertisement, may be determined according to a parameter such as a correct rate of the question and answer. The present disclosure does not limit the form of interaction.

In an example, the interactive advertisement may be an interactive game as described above. At least one of the image and the sound may be used to interact with the interactive game in the AR mode and determine the running parameter. For example, the interactive game is a shooting game, and the running parameter can be determined according to a number of times the basket is shot. For example, the interactive game is to search for treasures on the game screen, and the running parameter can be determined according to the number of treasures found. For another example, the interactive game is to avoid obstacles on the game screen based on images of the user swinging his head, and the running parameter can be determined based on the times of the user being hit by the obstacles.

FIG. 6 illustrates a flowchart of an advertisement interaction method according to some embodiments of the present disclosure. As shown in FIG. 6, the advertisement interaction method may include:

At step S61, in response to the interactive advertisement ending, result information is determined based on the running parameter.

In an embodiment, based on the running parameter, the result information of running the interactive advertisement can be determined. The result information includes reward information for running the interactive advertisement. For example, the higher the score, the more reward may be obtained. The reward information may indicate rewards obtained by running the interactive advertisement. In an example, the reward information may be a coupon of a product corresponding to the interactive advertisement. In an example, the interactive advertisement is an interactive game. The running parameter is determined according to the score of the interactive game, and the rewards can be determined by the running parameter. For example, a game score within a certain period of time can be determined, or a game score within a preset times of the game can be determined, thus the rewards can be determined by the game score. For example, the interactive game is a shooting game. The more the number of shots into the basket within a certain period of time, the higher the running parameter, the greater the discount rate of the coupon, or the more times the basket is shot within a certain number of shots. The higher the running parameter, the greater the discount rate of the coupon. In the example, the interactive advertisement is an online interactive game. For example, the interactive game is a shooting game. Another terminal running a shooting game online can be found for comparison. The terminal having a larger number of shots into the basket in a preset period of time or more shots into the basket within a preset number of shots may get a greater discount coupon.

In an embodiment, at step S13, a result page may be displayed at the end of the interactive advertisement, and the result page may include the result information obtained by running the interactive advertisement. For example, the result page may include information such as game scores and points, and may also include the reward information, such as discount information of a coupon.

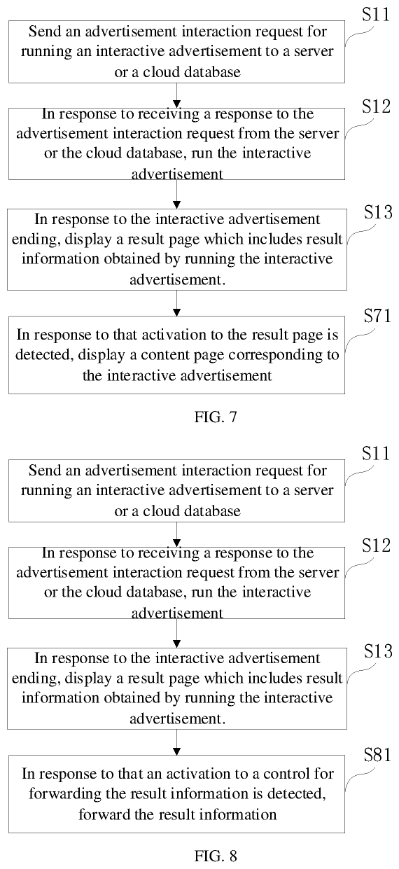

FIG. 7 illustrates a flowchart of an advertisement interaction method according to some embodiments of the present disclosure. As shown in FIG. 7, the advertisement interaction method further includes step S71.

At step S71, in response to that an activation to the result page is detected, a content page corresponding to the interactive advertisement is displayed.

In an embodiment, at step S71, the content page corresponding to the interactive advertisement may include at least one of the following: a consumption page for consuming the contents corresponding to the interactive advertisement; a page for promoting the consumption of the contents corresponding to the interactive advertisement.

In an example, the consumption page for consuming the contents corresponding to the interactive advertisement may include a content purchase page or a download page corresponding to the interactive advertisement. If the result page is triggered, for example, if a user clicks on the coupon, the consumption page for consuming the contents corresponding to the interactive advertisement is displayed. In an example, the contents corresponding to the interactive advertisement is an APP, the coupon may be a membership coupon of the APP, and the consumption page for consuming the contents corresponding to the interactive advertisement is the download page for downloading the APP. In an example, the contents corresponding to the interactive advertisement is a product, the coupon may be a coupon of the product, and the consumption page for consuming the contents corresponding to the interactive advertisement is the purchase page for purchasing the product.

In an example, the page for promoting the consumption of the contents corresponding to the interactive advertisement may include a page for redeeming the reward information, for example, a page for redeeming the coupon. If the user clicks on the coupon, the page for redeeming the coupon is displayed. For example, the page may include information such as a verification code of the coupon for redemption. In an example, the contents corresponding to the interactive advertisement is an APP, and the coupon may be a membership coupon of the APP. In response to detecting that the membership coupon is triggered, a verification code for the membership coupon may be displayed. In an example, the contents corresponding to the interactive advertisement is a product, and the coupon may be a coupon of the product. In response to detecting that the coupon of the product is triggered, a verification code for the coupon of the product may be displayed. The user may use the verification code to obtain a discount. Therefore, the verification code can promote the user to consume the contents corresponding to the interactive advertisement.

In an embodiment, the result page may also include a control for forwarding the result information.

FIG. 8 illustrates a flowchart of an advertisement interaction method according to some embodiments of the present disclosure. As shown in FIG. 8, the advertisement interaction method further includes step S81.

A step S81, in response to that an activation to a control for forwarding the result information is detected, the result information is forwarded.

In an embodiment, in response to that an activation to a control for forwarding the result information is detected, the control may forward the result information to a social network platform, such as Weibo or Moments, which can further spread the contents of the interactive advertisement. In an example, when the control for forwarding the result information is triggered, the control may forward the discount information of the coupon to the social network platform, and may spread the contents of the interactive advertisement together with the discount information. If a user of another terminal notices and triggers the result information on the social network platform, the server or cloud database can push the interactive advertisement to the another terminal based on the historical behavior information and/or user identity information of the user of the another terminal.

In this way, the contents of interactive advertising can be further spread and the advertising effect can be improved.

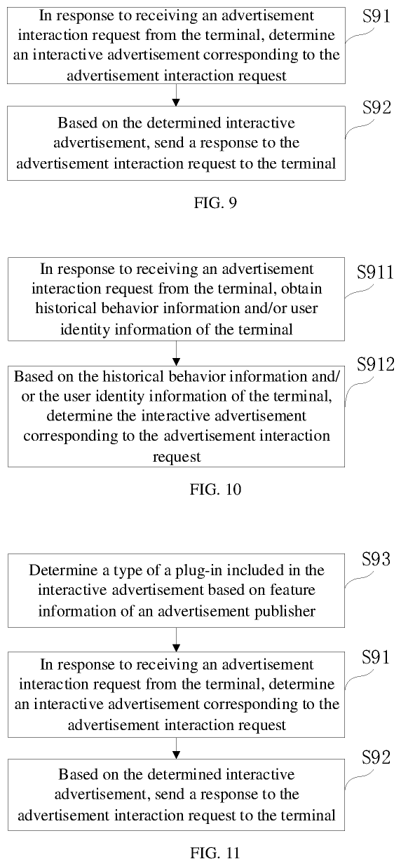

FIG. 9 illustrates a flowchart of an advertisement interaction method according to some embodiments of the present disclosure. As shown in FIG. 9, the method may be applied in the server or the could database and the method may include steps S91 to S92.

At step S91, in response to receiving an advertisement interaction request from the terminal, an interactive advertisement corresponding to the advertisement interaction request is determined;

At step S92, based on the determined interactive advertisement, a response to the advertisement interaction request is sent to the terminal.

According to the advertisement interaction method of the embodiment of the present disclosure, the determined interactive advertisement can be determined based on the advertisement interaction request from the terminal In this way, the interactive advertisement can be targeted to the user of the terminal, which can improve the effect of the interactive advertisement. Further, the stay time of the user on the interface of the targeted interactive advertisement can be effective increased. By interacting with users, more users can be attracted and the advertisement effect can be improved.

In an embodiment, the server or the cloud database may determine the interactive advertisement corresponding to the advertisement interaction request based on the historical behavior information and/or user identity information of the terminal.

FIG. 10 illustrates a flowchart of an advertisement interaction method according to some embodiments of the present disclosure. As shown in FIG. 10, step S91 may include steps S911 to S912.

At step S911, in response to receiving an advertisement interaction request from the terminal, historical behavior information and/or user identity information of the terminal is obtained;

At step S912, based on the historical behavior information and/or the user identity information of the terminal, the interactive advertisement corresponding to the advertisement interaction request is determined.

In an embodiment, at step S911, upon the terminal sending the advertisement interaction request, the terminal may simultaneously send the historical behavior information and/or the user identity information of the terminal, and the server or cloud database may receive the historical behavior information of the terminal and/or the user identity information of the terminal.

In an embodiment, if the terminal does not send the historical behavior information, the server or cloud database may send a command to the terminal for the terminal to provide the historical behavior information, so as to obtain the historical behavior information of the terminal.

In an embodiment, the server or cloud database may also obtain other information related to the user from the terminal, such as user identity information, etc. The present disclosure does not limit the type of information obtained by the server or the cloud database.

In an embodiment, at step S912, the server or the cloud database may determine the interactive advertisement corresponding to the advertisement interaction request based on the historical behavior information and/or the user identity information of the terminal. In an example, the historical behavior information may include historical purchase information of the user recorded on the terminal, and the server or cloud database may push advertisements of products related to the products previously purchased by the user according to the historical purchase information. For example, according to the historical purchase information, if the user has purchased a basketball before, the server or cloud database may push an advertisement of basketball sneaker. In an example, the server or cloud database may determine preferences of the user according to the historical purchase information of the user, and push the interactive advertisement according to the preferences of the user. For example, if the user has purchased a basketball before, the server or cloud database may push an interactive advertisement of a shotting game as the content of the advertisement. The historical behavior information may also include other historical information, such as exercise record and schedule of the user. The present disclosure does not limit the type of the historical behavior information.

In an embodiment, the server or cloud database may determine the interactive advertisement corresponding to the advertisement interaction request according to the user identity information of the terminal. In an example, the age of the user can be determined according to the identity information of the user. For example, if the user is 16 years old, the user may be a middle school student, and an advertisement of a book, an exercise book or a reference material may be pushed.

In an embodiment, at step S92, the server or the cloud database may send a response to the advertisement interaction request to the terminal based on the determined interactive advertisement. The response to the advertisement interaction request includes an address of the interactive advertisement or the contents of the interactive advertisement. In an example, the response is the contents of the interactive advertisement, the server or the cloud database may send the contents of the interactive advertisement to the terminal, and a SDK of the terminal may parse the contents of the interactive advertisement and load the interactive advertisement. In an example, the response is the address of the interactive advertisement, the server or cloud database may send the address of the interactive advertisement to the terminal, and the SDK of the terminal may access the address of the interactive advertisement and load the interactive advertisement.

In an embodiment, the server or cloud database may also determine the advertisement plug-in included in the interactive advertisement.

FIG. 11 illustrates a flowchart of an advertisement interaction method according to some embodiments of the present disclosure. As shown in FIG. 11, the advertisement interaction method also includes step S93.

At step S93, a type of a plug-in included in the interactive advertisement is determined based on feature information of an advertisement publisher.

In an embodiment, the interactive advertisement may be an interactive game, and the type of the plug-in available for the advertisement publisher in the interactive advertisement may be determined based on the feature information of the advertisement publisher. The feature information may include registration information and/or member information of the advertisement publisher. In an example, the advertisement publisher may upload a plug-in such as an advertisement icon for promoting a product or an APP to the server or the cloud database. When the server or cloud database pushes to the terminal, the server or the cloud database may determine which plug-in is available based on the feature information of the advertisement publisher.

In an example, based on the feature information of the advertisement publisher, the advertisement publisher may be determined as an ordinary publisher, and in the advertisement slot of the interactive advertisement, the advertisement publisher may use an icon which can be linked to an APP download page or a product purchase page, a description of the APP or the product, a link in the result page and a coupon, etc.

In an example, based on the feature information of the advertisement publisher, the advertisement publisher may be determined as a member who has subscribed multiple advertisement services. In the advertisement slot of the interactive advertisement, the advertisement publisher may use a brand icon of the APP or product, where the icon can be linked to an APP download page or a product purchase page, a description of the APP or the product, a link in the result page and a coupon, and may also insert a game element related to the product in the interactive game. For example, the advertisement publisher is a sports brand manufacturer and may use game elements related to their products in a shooting game. For example, the style of a sportswear worn by a character shooting in the shooting game may be consistent with the style of the sportswear of the sports brand manufacturer. Alternatively, a banner or slogan for promoting the APP or the product may be inserted into the interface of the interactive advertisement.

In an example, based on the feature information of the advertisement publisher, the advertisement publisher may be determined as a VIP member. In addition to using all the plug-ins mentioned above, the advertisement publisher may also customize the advertisement slot in the interactive game for inserting advertisements. For example, a personalized advertisement slot can be customized according to the contents of an interactive game. The interactive game may be a game of avoiding obstacles. The advertisement publisher may use the obstacles as advertisement slots and insert advertisements into the obstacles. The present disclosure does not limit the type of the plug-in.

According to the advertisement interaction method of the embodiments of the present disclosure, by running the interactive advertisement to interact with the user, the stay time of the user on the interface can be effectively increased, and interactive advertisement can be accurately pushed to the user. Through the interactive game, users can be attracted. Therefore, the advertisement contents can be further spread by forwarding the result information, and the advertisement effect can be improved. In addition, a SDK is implanted in the terminal and the SDK can parse or access the response to the advertisement interaction request from the server or the cloud database, so that the interactive advertisement contents do not need to be stored on the terminal. The size of the SDK can be within 5M to save the storage space of the terminal and the SDK does not need to be upgraded. Further, the SDK only needs to load or access the response from the server or the cloud database, which leads to simple operation, fast loading speed, and a loading time within 1 s.

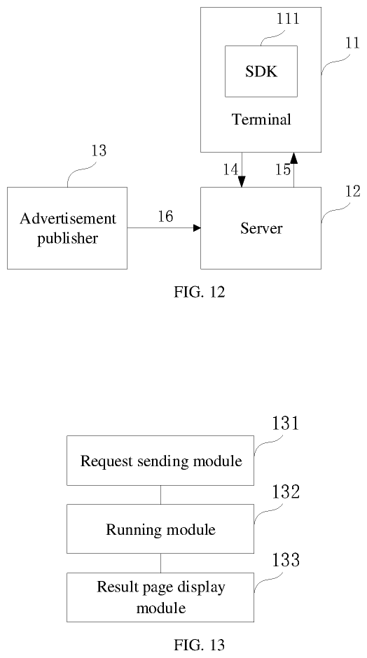

FIG. 12 illustrates a flowchart of an advertisement interaction method according to some embodiments of the present disclosure. As shown in FIG. 12, the terminal 11 includes a SDK 111, and the size of the SDK 111 may be within 5M, which saves the storage space of the terminal.

An advertisement publisher 13 may upload plug-ins 16 for the advertisement to the server 12. The server 12 may determine which plug-in can be used in the interactive advertisement based on the feature information of the advertisement publisher 13. For example, if the advertisement publisher is an ordinary publisher, the advertisement publisher may only insert icon which can be linked to an APP download page or a product purchase page, a description of the APP or the product, a link in the result page and a coupon into the advertisement slot of the interactive advertisement.

When a control of the terminal for starting the interactive advertisement is triggered, the SDK 111 may send an advertisement interaction request 14 to the server 12. For example, when the icon for running the interactive advertisement inserted in the interface of the APP is triggered, SDK 111 may send an advertisement interaction request 14 to server 12, and server 12 may obtain the historical behavior information and/or the user identity information of the terminal, and determine the interactive advertisement to be pushed based on the historical behavior information and/or the user identity information. That is, the interactive advertisement is pushed to the terminal based on the historical behavior information and/or the user identity information of the terminal. After the interactive advertisement is determined, the server 12 may send a response 15 to the advertisement interaction request to the terminal 11, and the response may include the address of the interactive advertisement or the contents of the interactive advertisement.

The interactive advertisement may be an interactive game. The SDK 111 may load the contents of the interactive game or access the address of the interactive game, and start an image acquisition component and/or a sound acquisition component of the terminal 11 to overlap the acquired images and/or sounds with virtual information in the interactive game in an AR mode, so that the current user of the terminal 11 can interact with the interactive game, that is, the current user can play the interactive game. The terminal 11 may determine a running parameter of the interactive game based on the image and/or the sound of the current user of the terminal, that is, a score gained by the current user while playing the interactive game. The terminal 11 may determine the result information of the interactive game based on the running parameter, that is, the reward information such as a coupon obtained by the current user while playing the interactive game. The higher the score, the greater the discount rate. The terminal 11 may display a result page when the interactive game ends. The result page includes the result information, and may also include a control for forwarding the result information. If the result page is triggered, for example, the current user of the terminal triggers a coupon in the result page, then jump to a consumption page of the contents corresponding to the interactive advertisement, such as a download page of the APP or a purchase page of the product. In response to that an activation to a control for forwarding the result information is detected, the result information can be forwarded to a social network platform to further spread the interactive advertisement.

It can be understood that, without violating the principle and logic, the various method embodiments mentioned in the present disclosure can be combined with each other to form a combined embodiment, which is limited in length and will not be repeated in the present disclosure.

In addition, the present disclosure also provides image processing apparatuses, electronic devices, computer-readable storage media, and programs, all of which can be used to implement any one of the image processing methods provided by the present disclosure, corresponding embodiments and descriptions, and reference can be made to corresponding disclosures in the method section, which are not described herein again.

FIG. 13 illustrates a block diagram of an advertisement interaction apparatus according to some embodiments of the present disclosure. As shown in FIG. 13, the apparatus may include:

a request sending module 131, configured to send an advertisement interaction request for running an interactive advertisement to a server or a cloud database;

a running module 132, configured to, in response to receiving a response to the advertisement interaction request from the server or the cloud database, run the interactive advertisement;

The result page display module 133 is configured to, in response to the interactive advertisement ending, display a result page, and the result page includes result information obtained by running the interactive advertisement.

In an embodiment, the interactive advertisement includes an interactive game.

In an embodiment, the result information includes reward information for running the interactive advertisement.

In an embodiment, the response to the advertisement interaction request includes an address of the interactive advertisement or contents of the interactive advertisement.

In an embodiment, the terminal includes a SDK, and the SDK is used to send the advertisement interaction request for running the interactive advertisement to the server or the cloud database and to run the interactive advertisement.

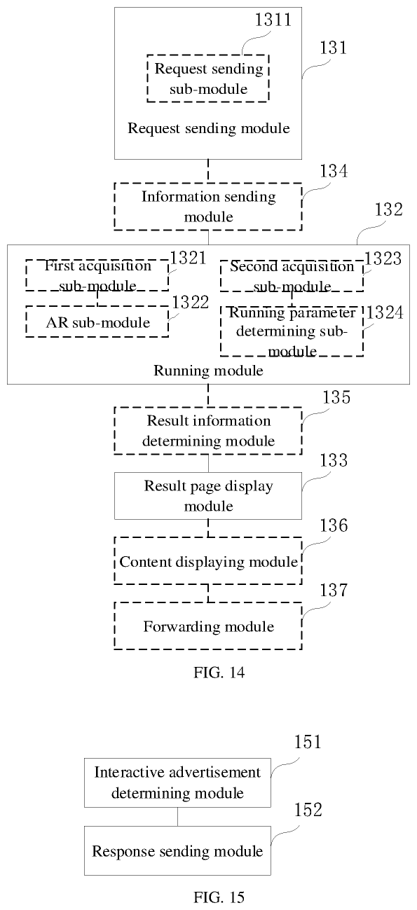

FIG. 14 illustrates a block diagram of an advertisement interaction apparatus according to some embodiments of the present disclosure. As shown in FIG. 14, the request sending module 131 may include:

a request sending sub-module 1311, configured to send the advertisement interaction request to the server or the cloud database when a control of the terminal for starting the interactive advertisement is triggered.

In an embodiment, the apparatus may further include:

an information sending module 134, configured to send historical behavior information and/or user identity information of the terminal to the server or the cloud database when the control for starting the interactive advertisement of the terminal is triggered.

In an embodiment, the running module 132 may include:

a first acquisition sub-module 1321, configured to, in response to receiving the response to the advertisement interaction request from the server or the cloud database, start at least one of an acquisition component and a sound acquisition component of the terminal to acquire at least one of an image and a sound;

an AR sub-module 1322, configured to run the interactive advertisement in an AR mode based on the at least one of the image and the sound.

In an embodiment, the AR sub-module 1322 may include:

an image identifying sub-module, configured to identify an object involved in the image;

an overlay displaying sub-module, configured to overlay display the identified object and virtual contents of the interactive advertisement in an AR mode.

In an embodiment, the AR sub-module 1322 may include:

an image identifying sub-module, configured to identify one or more of a line-of-sight, an expression, a posture, and a gesture of a user of the terminal based on the image;

a first interaction sub-module, configured to interact with the virtual contents of the interactive advertisement based on the one or more of the line-of-sight, the expression, the posture, and the gesture.

In an embodiment, the AR sub-module 1322 may include:

a sound identifying sub-module, configured to identify the sound;

a second interaction sub-module, configured to interact with the virtual contents of the interactive advertisement based on a result of the identification.

In an embodiment, the running module 132 may include:

a second acquisition sub-module 1323, configured to, in response to receiving the response to the advertisement interaction request from the server or the cloud database, start at least one of the image acquisition component and the sound acquisition component of the terminal to acquire the at least one of the image and the sound;

a running parameter determining sub-module 1324, configured to determine a running parameter of the interactive advertisement based on the at least one of the image and the sound.

In an embodiment, the apparatus may further include:

a result information determining module 135, configured to, in response to the interactive advertisement ending, determine the result information based on the running parameter.

In an embodiment, the apparatus may further include:

a content displaying module 136, configured to, in response to that an activation to the result page is detected, display a content page corresponding to the interactive advertisement upon.

In an embodiment, the content page corresponding to the interactive advertisement includes at least one of the following:

a consumption page for consuming contents corresponding to the interactive advertisement;

a page for promoting consumption of the contents corresponding to the interactive advertisement.

In an embodiment, the apparatus may further include:

a forwarding module 137, configured to, in response to that an activation to a control for forwarding the result information is detected, forward the result information.

FIG. 15 illustrates a block diagram of an advertisement interaction apparatus according to some embodiments of the present disclosure. As shown in FIG. 15, the apparatus may include:

an interactive advertisement determining module 151, configured to, in response to receiving an advertisement interaction request from the terminal, determine an interactive advertisement corresponding to the advertisement interaction request;

a response sending module 152, configured to send a response to the advertisement interaction request to the terminal based on the determined interactive advertisement.

In an embodiment, the response to the advertisement interaction request includes an address of the interactive advertisement or contents of the interactive advertisement.

In an embodiment, the interactive advertisement includes an interactive game.

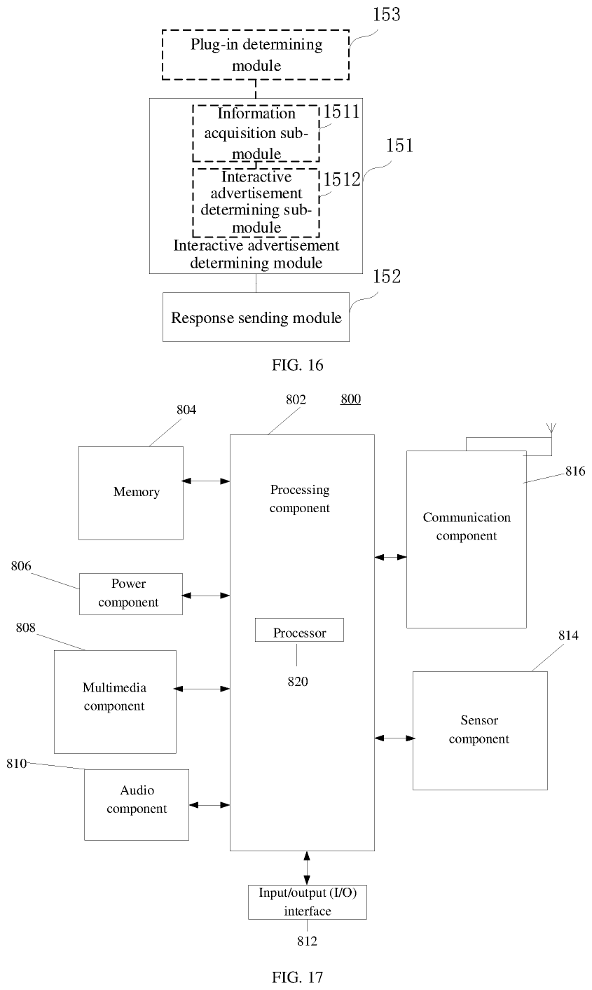

FIG. 16 illustrates a block diagram of an advertisement interaction apparatus according to some embodiments of the present disclosure. As shown in FIG. 16, the interactive advertisement determining module 151 may include:

an information acquisition sub-module 1511, configured to, in response to receiving an advertisement interaction request from a terminal, obtain historical behavior information and/or user identity information of the terminal;

an interactive advertisement determining sub-module 1512, configured to determine the interactive advertisement corresponding to the advertisement interaction request based on the historical behavior information and/or the user identity information of the terminal.

In an embodiment, the apparatus may further include:

a plug-in determining module 153, configured to determine a type of a plug-in included in the interactive advertisement based on feature information of an advertisement publisher.

The embodiments of the present disclosure also provide a computer readable storage medium storing computer program instructions, when the program instructions are executed by a processor, the method according to any of the embodiments above are executed. The computer-readable storage medium may be a non-volatile computer-readable storage medium.

The embodiments of the present disclosure also provide an electronic device, which includes a processor, and a memory storing instructions executable by the processor. The processor is configured to execute the above methods.

The electronic device can be provided as a terminal, a server or other form of device.

FIG. 17 illustrates a block diagram of an electronic device 800 according to some embodiments of the present disclosure. For example, the electronic device 800 can be a mobile phone, a computer, a digital broadcast terminal, a message transmitting and receiving device, a gaming console, a tablet device, a medical device, a fitness device, a personal digital assistant, and the like terminal.

Referring to FIG. 17, the electronic device 800 can include one or more of the following components: processing component 802, memory 804, power component 806, multimedia component 808, audio component 810, input/output (I/O) interface 812, sensor component 814, and a communication component 816.

Processing component 802 typically controls the overall operation of the electronic device 800, such as operations associated with display, telephone calls, data communications, camera operations, and recording operations. Processing component 802 can include one or more processors 820 to execute instructions to perform all or part of the steps described above. Moreover, processing component 802 can include one or more modules to facilitate interaction between component 802 and other components. For example, processing component 802 can include a multimedia module to facilitate interaction between multimedia component 808 and processing component 802.

The memory 804 is to store various types of data to support the operation of the electronic device 800. Examples of such data include instructions for any application or method operating on the electronic device 800, contact data, phone book data, messages, pictures, videos, and the like. The memory 804 can be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, disk or optical Disk.

Power component 806 provides power to various components of the electronic device 800. Power component 806 can include a power management system, one or more power sources, and other components associated with generating, managing, and distributing power for the electronic device 800.

The multimedia component 808 includes a screen between the electronic device 800 and the user that provides an output interface. In some examples, the screen can include a liquid crystal display (LCD) and a touch panel (TP). If the screen includes a touch panel, the screen can be implemented as a touch screen to receive input signals from the user. The touch panel includes one or more touch sensors to sense touches, swipes, and gestures on the touch panel. The touch sensor may sense not only the boundary of the touch or sliding action, but also the duration and pressure associated with the touch or slide operation. In some examples, the multimedia component 808 includes a front camera and/or a rear camera. The front camera and/or rear camera may receive external multimedia data when the electronic device 800 is in an operating mode, such as a photographing mode or a video mode. Each front and rear camera can be a fixed optical lens system or have focal length and optical zoom capabilities.

The audio component 810 is configured to output and/or input an audio signal. For example, audio component 810 includes a microphone (MIC) that is configured to receive an external audio signal when the electronic device 800 is in an operational mode, such as a call mode, a recording mode, and a voice recognition mode. The received audio signal may be further stored in memory 804 or transmitted via communication component 816. In some examples, audio component 810 also includes a speaker for outputting an audio signal.

The I/O interface 812 may provide interfaces between the processing component 802 and peripheral interface modules. The peripheral interface modules may include a keyboard, a click wheel, buttons and so on. These buttons may include, but are not limited to, a home button, a volume button, a start button, and a lock button.

Sensor component 814 includes one or more sensors for providing electronic device 800 with a status assessment of various aspects. For example, the sensor component 814 may detect the on/off status of the electronic device 800, and relative positioning of component, for example, the component is a display and a keypad of the electronic device 800. The sensor component 814 may also detect a change in position of the electronic device 800 or a component of the electronic device 800, a presence or absence of the contact between a user and the electronic device 800, an orientation or an acceleration/deceleration of the electronic device 800, and a change in temperature of the electronic device 800. Sensor component 814 can include a proximity sensor configured to detect the presence of nearby objects without any physical contact. Sensor component 814 may also include a light sensor, such as a CMOS or CCD image sensor, for use in imaging applications. In some embodiments, the sensor component 814 can also include an acceleration sensor, a gyro sensor, a magnetic sensor, a pressure sensor, or a temperature sensor.

Communication component 816 is configured to facilitate wired or wireless communication between the electronic device 800 and other devices. The electronic device 800 can access a wireless network based on a communication standard, such as WiFi, 2G or 3G, or a combination thereof. In an exemplary example, communication component 816 receives broadcast signals or broadcast associated information from an external broadcast management system via a broadcast channel. In an exemplary example, the communication component 816 also includes a near field communication (NFC) module to facilitate short range communication. For example, the NFC module can be implemented based on radio frequency identification (RFID) technology, infrared data association (IrDA) technology, ultra-wideband (UWB) technology, Bluetooth (BT) technology, and other technologies.

In an exemplary example, the electronic device 800 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic elements for performing the method described in any of the above examples.

In an exemplary example, there is also provided a non-transitory computer readable storage medium including instructions, such as a memory 804 including instructions executable by processor 820 of the electronic 800 to perform the above method.

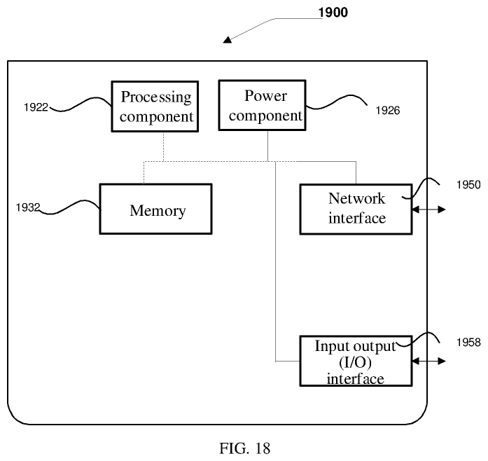

FIG. 18 illustrates a block diagram of an electronic device 1900 according to some embodiments of the present disclosure. For example, the electronic device 1900 may be provided as a server. Referring to FIG. 18, the electronic device 1900 includes a processing component 1922, which further includes one or more processors, and memory resources indicate by the memory 1932 for storing instructions executable by the processing component 1922, such as application programs. The application programs stored in the memory 1932 may include one or more modules each corresponding to a set of instructions. In addition, the processing component 1922 is configured to execute instructions to perform the above-described methods.

The electronic device 1900 may also include a power component 1926 configured to perform power management of the electronic device 1900, a wired or wireless network interface 1950 configured to connect the electronic device 1900 to the network, and an input output (I/O) interface 1958. The electronic device 1900 can operate based on an operating system stored in the memory 1932, such as Windows Server™, Mac OS X™, Unix™, Linux™, FreeBSD™ or the like.

In an exemplary embodiment, a non-volatile computer-readable storage medium is also provided, such as the memory 1932 including computer program instructions, which can be executed by the processing component 1922 of the electronic device 1900 to implement the above methods.

The present disclosure can be a system, method and/or computer program product. The computer program product may include a computer-readable storage medium storing computer-readable program instructions thereon for causing a processor to implement various aspects of the present disclosure.

The computer-readable storage medium may be a tangible device that can maintain and store instructions for an instruction execution device. The computer-readable storage medium may be, for example, but not limited to, an electrical storage device, a magnetic storage device, an optical storage device, an electromagnetic storage device, a semiconductor storage device, or any suitable combination of the foregoing. More specific examples of computer-readable storage media (non-exhaustive list) include: portable computer disk, hard disk, random access memory (RAM), read-only memory (ROM), erasable programmable read-only memory ((EPROM) or flash memory), static random access memory (SRAM), portable compact disk read-only memory (CD-ROM), digital versatile disk (DVD), memory stick, floppy disk, a mechanically encoded device such as punch-cards or raised structures in a groove having instructions recorded thereon, and any suitable combination of the foregoing. The computer-readable storage medium used here is not interpreted as a transient signal itself, such as radio waves or other freely propagating electromagnetic waves, electromagnetic waves propagating through waveguides or other transmission media (for example, light pulses through fiber optic cables), or electrical signals transmitted through wires.

The computer-readable program instructions described herein can be downloaded from a computer-readable storage medium to various computing/processing devices, or downloaded to an external computer or external storage device via a network, such as the Internet, a local area network (LAN), a wide area network (WAN), and/or a wireless network. The network may include copper transmission cables, optical fiber transmission, wireless transmission, routers, firewalls, switches, gateway computers, and/or edge servers. The network adapter card or network interface in each computing/processing device receives computer-readable program instructions from the network, and forwards the computer-readable program instructions for storage in the computer-readable storage medium in each computing/processing device.

The computer-readable program instructions for carrying out the above-described methods may be assembler instructions, instruction-set-architecture (ISA) instructions, machine instructions, machine dependent instructions, microcode, firmware instructions, state-setting data, or source code or object code written in any combination of one or more programming languages, including an object oriented programming language such as Smalltalk, C++ and the like, and conventional procedural programming languages such as “C” language and the like. The computer-readable program instructions can be executed entirely on the user's computer, partly on the user's computer, executed as a stand-alone software package, executed partly on the user's computer and partly on a remote computer, or entirely on the remote computer or server. In the case that involves the remote computer, the remote computer can be connected to the user's computer through any kind of network, including a local area network or a wide area network, or it can be connected to an external computer (for example, using an Internet service provider to access the Internet connection). In some embodiments, an electronic circuit, such as a programmable logic circuit, a field programmable gate array (FPGA), or a programmable logic array (PLA), can be customized by using the status information of the computer-readable program instructions. The computer-readable program instructions are executed to realize various aspects of the present application.

Here, various aspects of the present application are described with reference to the flowcharts and/or block diagrams of the methods, devices (systems) and computer program products according to the embodiments of the present disclosure. It should be understood that each block of the flowcharts and/or block diagrams and combinations of blocks in the flowcharts and/or block diagrams can be implemented by computer-readable program instructions.

These computer-readable program instructions can be provided to the processor of a general-purpose computer, a special-purpose computer, or other programmable data processing device, thereby producing a machine such that when these instructions are executed by the processor of the computer or other programmable data processing device, A device that implements the functions/actions specified in one or more blocks in the flowchart and/or block diagram is produced. It is also possible to store these computer-readable program instructions in a computer-readable storage medium. These instructions make computers, programmable data processing apparatuses, and/or other devices work in a specific manner, so that the computer-readable medium storing instructions includes An article of manufacture, which includes instructions for implementing various aspects of the functions/actions specified in one or more blocks in the flowchart and/or block diagram.

It is also possible to load computer-readable program instructions on a computer, other programmable data processing device, or other equipment, so that a series of operation steps are executed on the computer, other programmable data processing device, or other equipment to produce a computer-implemented process, So that the instructions executed on the computer, other programmable data processing apparatus, or other equipment realize the functions/actions specified in one or more blocks in the flowcharts and/or block diagrams.

The flowcharts and block diagrams in the drawings show the possible implementation of the system architecture, functions, and operations of the system, method, and computer program product according to multiple embodiments of the present disclosure. In this regard, each block in the flowchart or block diagram may represent a module, program segment, or part of an instruction, and the module, program segment, or part of an instruction contains one or more functions for implementing the executable instructions of specified logical functions. In some alternative embodiments, the functions marked in the block may also occur in a different order from the order marked in the drawings. For example, two consecutive blocks can actually be executed in parallel, or they can sometimes be executed in the reverse order, depending on the functions involved. It should also be noted that each block in the block diagram and/or flowchart, and the combination of the blocks in the block diagram and/or flowchart, can be implemented by a dedicated hardware-based system that performs the specified functions or actions or it can be realized by a combination of dedicated hardware and computer instructions.

The embodiments of the present application have been described above, and the above description is exemplary and not exhaustive, and is not limited to the disclosed embodiments. Without departing from the scope and spirit of the described embodiments, many modifications and changes are obvious to those of ordinary skill in the art. The choice of terms used herein is intended to best explain the principles, practical applications, or technical improvements of the technologies in the market, or to enable other ordinary skilled in the art to understand the embodiments disclosed herein.

1. An advertisement interaction method, being applicable to a terminal, comprising:
sending an advertisement interaction request for running an interactive advertisement to a server or a cloud database;
in response to receiving a response to the advertisement interaction request from the server or the cloud database, running the interactive advertisement;
in response to the interactive advertisement ending, displaying a result page which comprises result information obtained from the running of the interactive advertisement.

2. The method of claim 1, wherein sending the advertisement interaction request for running the interactive advertisement to the server or the cloud database comprises:
in response to that a control of the terminal for starting the interactive advertisement is triggered, sending the advertisement interaction request to the server or the cloud database.

3. The method of claim 1, further comprising:
in response to that a control of the terminal for starting the interactive advertisement is triggered, sending historical behavior information and/or user identity information of the terminal to the server or the cloud database.

4. The method of claim 1, wherein in response to receiving the response to the advertisement interaction request from the server or the cloud database, running the interactive advertisement comprises:
in response to receiving the response to the advertisement interaction request from the server or the cloud database, starting at least one of an image acquisition component and a sound acquisition component of the terminal to acquire at least one of an image and a sound;
running the interactive advertisement in an augmented reality (AR) mode based on the at least one of the image and the sound.

5. The method of claim 4, wherein running the interactive advertisement in the AR mode based on the at least one of the image and the sound comprises:
identifying an object involved in the image;
overlay displaying the identified object and virtual contents of the interactive advertisement in the AR mode.

6. The method of claim 4, wherein running the interactive advertisement in the AR mode based on the at least one of the image and the sound comprises:
identifying, based on the image, one or more of a line-of-sight, an expression, a posture, and a gesture of a user of the terminal;
interacting with virtual contents of the interactive advertisement based on the one or more of the line-of-sight, the expression, the posture, and the gesture.

7. The method of claim 4, wherein running the interactive advertisement in the AR mode based on the at least one of the image and the sound comprises:
identifying the sound;
interacting with virtual contents of the interactive advertisement based on a result of the identification.

8. The method of claim 1, wherein in response to receiving the response to the advertisement interaction request from the server or the cloud database, running the interactive advertisement comprises:
in response to receiving the response to the advertisement interaction request from the server or the cloud database, starting at least one of an image acquisition component and a sound acquisition component of the terminal to acquire at least one of the image and the sound;
determining a running parameter of the interactive advertisement based on the at least one of the image and the sound.

9. The method of claim 8, further comprising:
in response to the interactive advertisement ending, determining the result information based on the running parameter.

10. The method of claim 1, further comprising:
in response to that an activation to the result page is detected, displaying a content page corresponding to the interactive advertisement.
and/or
the content page corresponding to the interactive advertisement comprises at least one of the following:
a consumption page for consuming contents corresponding to the interactive advertisement;
a page for promoting consumption of the contents corresponding to the interactive advertisement.

11. The method of claim 1, further comprising:
in response to that an activation to a control for forwarding the result information is detected, forwarding the result information.

12. The method of claim 1, wherein the result information comprises reward information for running the interactive advertisement;
and/or
the interactive advertisement comprises an interactive game.

13. The method of claim 1, wherein the response to the advertisement interaction request comprises an address of the interactive advertisement or contents of the interactive advertisement.

14. The method of claim 1, wherein
the terminal comprises a software development kit (SDK), and
the SDK is configured to send the interactive advertisement request for running the interactive advertisement to the server or the cloud database and to run the interactive advertisement.

15. An advertisement interaction method, being applicable to a server or a cloud database, comprising:
in response to receiving an advertisement interaction request from a terminal, determining an interactive advertisement corresponding to the advertisement interaction request;
sending, based on the determined interactive advertisement, a response to the advertisement interaction request to the terminal.

16. The method of claim 15, wherein in response to receiving the advertisement interaction request from the terminal, determining the interactive advertisement corresponding to the advertisement interaction request comprises:
in response to receiving the advertisement interaction request from the terminal, obtaining historical behavior information and/or user identity information of the terminal;
determining the interactive advertisement corresponding to the advertisement interaction request based on the historical behavior information and/or the user identity information of the terminal.

17. The method of claim 15, further comprising:
determining a type of a plug-in included in the interactive advertisement based on feature information of an advertisement publisher.

18. The method of claim 15, wherein the response to the advertisement interaction request comprises an address of the interactive advertisement or contents of the interactive advertisement;
and/or
the interactive advertisement comprises an interactive game.

19. An electronic device, comprising:
a processor;
a memory for storing executable instructions by the processor;
wherein the processor is configured to execute the following operations:
sending an advertisement interaction request for running an interactive advertisement to a server or a cloud database;
in response to receiving a response to the advertisement interaction request from the server or the cloud database, running the interactive advertisement;
in response to the interactive advertisement ending, displaying a result page which comprises result information obtained from the running of the interactive advertisement.

20. An electronic device, comprising:
a processor;
a memory for storing executable instructions by the processor;
wherein the processor is configured to execute the method of claim 15.
